(19) United States
(12) Patent Application Publication
(10) Pub. No.: US 2025/0389298 A1
(43) Pub. Date: Dec. 25, 2025

(54) Bushing With Integrated Rotary Seal

(71) Applicant: The Pullman Company LLC, Northville, MI (US)

(72) Inventor: Michael BIXLER, Milan, OH (US)

(73) Assignee: The Pullman Company LLC, Northville, MI (US)

(21) Appl. No.: 18/748,447

(22) Filed: Jun. 20, 2024

(51) Int. Cl. F16C 33/74; F16C 17/02; F16C 33/20

(52) U.S. Cl. CPC F16C 33/74; F16C 17/02; F16C 33/20

(57) ABSTRACT

An elastomeric bushing comprises an inner sleeve including a first end face and an opposite second end face. A bearing circumscribes the inner sleeve. An elastomer is disposed around and directly engages the bearing. The elastomer includes a first seal gland. An outer sleeve is disposed around the bearing and the elastomer. The outer sleeve is spaced apart from the inner sleeve and directly engages the elastomer. A one-piece monolithic first cap includes an end wall and a side wall surrounding a portion of the inner sleeve and a portion of the bearing. The end wall radially inwardly extends from the sidewall and overlaps the first end face of the inner sleeve. The stepped sidewall includes an inner surface positioned in engagement with the first seal gland.

### FIELD

The present disclosure relates to an elastomeric bushing assembly having improved sealing characteristics.

### BACKGROUND

Vehicles are commonly designed using independent front and/or rear suspension systems to connect unsprung components of the vehicle, such as the wheels and brakes, to the chassis of the vehicle. Independent suspension systems typically include an upper control arm, a lower control arm, and a hub or knuckle that supports one of the wheels. Each control arm is attached to a frame or other support structure of the vehicle using one or more bushing assemblies. The bushing assemblies decouple torsional input from other articulation directions. Each bushing assembly typically consists of an outer metal sleeve that is pressed into the control arm, an elastomeric bushing positioned within the outer metal sleeve, a hollow cylindrical bearing and an inner metal sleeve that extends through the center of the cylindrical bearing. The inner metal sleeve is connected to a bracket on the frame or other support structure of the vehicle. In some examples, a bolt extends through the inner metal sleeve and secures the control arm and the bushing assembly to the frame by mating with an appropriate bracket. As the vehicle travels, relative movement between the chassis and the unsprung components of the vehicle is accommodated by flexing of a spring. The flexing of the spring causes the ends of the control arms to pivot on the bushing assemblies.

The bearing facilitates the pivotal motion of the inner metal sleeve relative to the outer metal sleeve and the elastomeric bushing. The elastomeric bushing operates to isolate the vehicle from shock. The elastomeric bushing, which is located between the outer metal sleeve and the inner metal sleeve, effectively isolates the frame of the vehicle from the unsprung components. In certain high load applications, the ends of the outer metal sleeve are curved or bent over the ends of the inner metal sleeve in order to further encapsulate the elastomeric bushing. The curving or bending of the ends of the outer metal sleeve and thus the further encapsulating of the elastomeric bushing improves the radial spring rate, the axial spring rate, axial retention, and the durability of the elastomeric bushing.

While these elastomeric bushing assemblies have performed satisfactorily in the field, contamination problems can occur because dirt, salt, dust and the like may become present at an interface between the cylindrical bearing and the inner metal sleeve. Contamination may undesirably accelerate wear within the bushing assembly and therefore can decrease service life. Thus, there remains a need for the development of new bushing assemblies with improvements in sealing performance and durability, while minimizing the manufacturing costs associated with bushing assemblies.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An elastomeric bushing comprises an inner sleeve including a first end face and an opposite second end face. A bearing circumscribes the inner sleeve. An elastomer is disposed around and directly engages the bearing. The elastomer includes a first seal gland. An outer sleeve is disposed around the bearing and the elastomer. The outer sleeve is spaced apart from the inner sleeve and directly engages the elastomer. A one-piece monolithic first cap includes an end wall and a side wall surrounding a portion of the inner sleeve and a portion of the bearing. The end wall radially inwardly extends from the sidewall and overlaps the first end face of the inner sleeve. The stepped sidewall includes an inner surface positioned in engagement with the first seal gland.

In an alternate arrangement, a one-piece monolithic second cap overlaps the second end face of the inner sleeve and surrounds a portion of the inner sleeve as well as a portion of the bearing. The second cap includes a stepped cylindrical sidewall positioned in engagement with a second seal gland of the elastomer.

In another arrangement, a first annular void and a spaced apart second annular void are provided at opposite ends of the elastomer. A portion of the first cap may be positioned within the first annular void. Similarly, a portion of the second cap may be positioned within the second annular void.

### BRIEF DESCRIPTION OF THE DRAWINGS

The present disclosure will become more fully understood from the detailed description and the accompanying drawings, wherein:

FIG. 1 is a perspective view of an exemplary elastomeric bushing assembly constructed in accordance with the teachings of the present disclosure;

FIG. 2 is an exploded perspective view of the elastomeric bushing assembly depicted in FIG. 1;

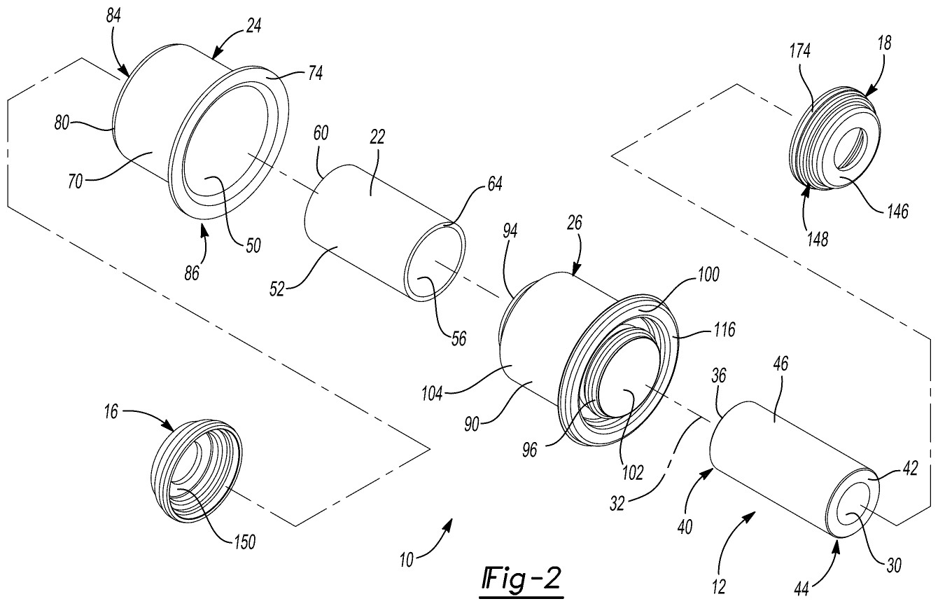

FIG. 3 is cross-sectional side view of a bearing assembly of the elastomeric bushing assembly; and

FIG. 4 is an enlarged fragmentary cross-sectional view of a portion of the elastomeric bushing assembly.

In the drawings, reference numbers may be reused to identify similar and/or identical elements.

### DETAILED DESCRIPTION

Example embodiments will now be described more fully with reference to the accompanying drawings.

Example embodiments are provided so that this disclosure will be thorough, and fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

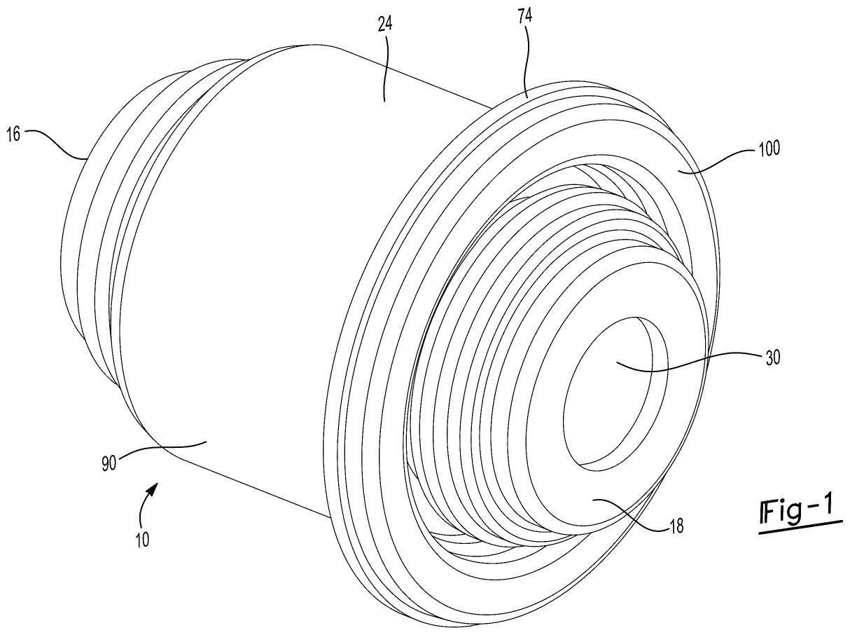

With reference to FIG. 1, an elastomeric bushing assembly 10 comprises an inner sleeve 12, a bearing assembly 14, a first cap 16, and a second cap 18. Bearing assembly 14 includes a hollow cylindrical bearing 22, an outer sleeve 24, and an elastomer 26 radially positioned therebetween. Inner sleeve 12 is illustrated as a metal tube having a generally circular cylindrical shape. It is contemplated to possibly have different inner sleeves, including but not limited to, a solid tubular component such as a bar pin. In the embodiment depicted in the figures, inner sleeve 12 includes a substantially cylindrical bore 30 extending along a longitudinal axis 32. Inner sleeve 12 includes a first end face 36 at a first end 40 and a second end face 42 positioned at a second end 44 opposite first end 40. Inner sleeve 12 includes a cylindrically shaped outer surface 46. Inner sleeve 12 may be constructed from a low-carbon steel such as SAE 1008 or SAE 1010.

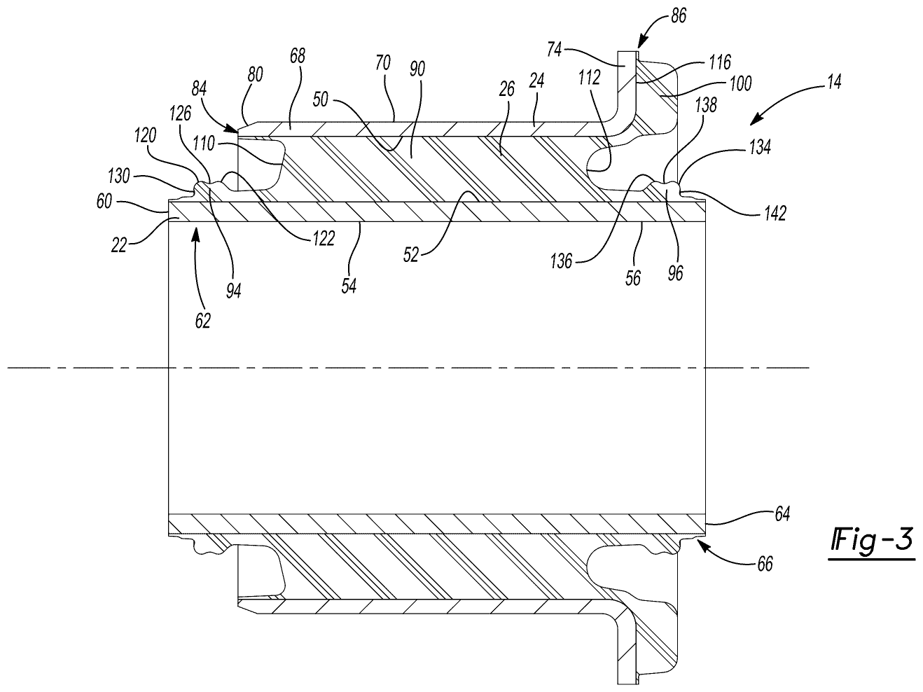

As best depicted in FIG. 3, bearing assembly 14 includes elastomer 26 bonded to an inner cylindrical surface 50 of outer sleeve 24 and an outer cylindrical surface 52 of bearing 22. Elastomer 26 is constructed as a one-piece monolithic structure operable to provide a damping function for loads applied to elastomeric bushing assembly 10. Elastomer 26 may be constructed from natural rubber, EDPM, or the like. The elastomer may be impregnated with a lubricant.

Bearing 22 includes a cylindrical inner surface 54 that is sized slightly larger than outer surface 46 of inner sleeve 12 such that a slip-fit exists between inner sleeve 12 and bearing assembly 14. Relative rotation between these components may occur during operation. It is contemplated that cylindrical bearing 22 is constructed primarily from low carbon steel. An inner cylindrical surface of bearing 22 may be optionally coated with a layer of PTFE as indicated at reference numeral 56. This layer reduces friction between cylindrical bearing 22 and inner sleeve 12.

Cylindrical bearing 22 includes a first end face 60 positioned at a first end 62 as well as a second end face 64 positioned at an opposite second end 66. It should be appreciated that an axial extent of cylindrical bearing 22 is defined as the distance between first end face 60 and second end face 64. The axial extent of cylindrical bearing 22 is less than an axial extent of inner sleeve 12 being defined as a longitudinal distance between first end face 36 and second end face 42. A portion of inner sleeve 12 extends beyond each end of cylindrical bearing 22.

Outer sleeve 24 includes a substantially cylindrically shaped body 68 including an outer cylindrically shaped surface 70 positioned opposite inner cylindrical surface 50. Outer sleeve 24 further includes a flange 74 radially outwardly extending from cylindrical body 68. To ease installation of elastomeric bushing assembly 10 within a suspension member of a vehicle, outer sleeve 24 may include a chamfer 80 positioned at a first end 84 of outer sleeve 24. Flange 74 is positioned at an opposite second end 86 of outer sleeve 24. An axial extent of outer sleeve 24 is less than the axial extent of cylindrical bearing 22. Outer sleeve 24 may be constructed from low carbon steel.

Elastomer 26 includes a cylindrical body 90, a first seal gland 94, a second seal gland 96 and a bumper 100. An inner cylindrical surface 102 of elastomer 26 is bonded to outer surface 52 of bearing 22. An outer cylindrical surface 104 of elastomer 26 is bonded to inner cylindrical surface 50 of outer sleeve 24. Elastomer 26 also includes a first annular void 110 and an opposite second annular void 112 positioned at opposite ends of body 90. First annular void 110 and second annular void 112 provide pockets for receipt of first cap 16 and second cap 18, respectively, as will be described in greater detail hereinafter. The size and shape of annular voids 110, 112 contribute to determining the axial and radial compression rates of elastomer 26.

Bumper 100 is bonded to an end face 116 of flange 74. After elastomeric bushing has been installed in a vehicle, bumper 100 will be positioned adjacent to or proximate a vehicular structure when elastomeric bushing assembly 10 is in an unloaded state. During certain applications and loads, outer sleeve 24 and bumper 100 may be urged into engagement with the vehicle structure. Bumper 100 acts as a spring and a travel limit stop to resist further axial translation of outer sleeve 24.

First seal gland 94 includes a circumferentially extending first rib 120 and a circumferentially extending second rib 122 longitudinally spaced apart from one another. A trough 126 circumferentially extends around first seal gland 94 longitudinally positioned between first rib 120 and second rib 122. First seal gland 94 includes an annular first land 130. Second seal gland 96 is constructed substantially similarly to first seal gland 94. Accordingly, second seal gland 96 includes a circumferentially extending third rib 134 and a longitudinally spaced apart and circumferentially extending fourth rib 136. A trough 138 circumferentially extends and is longitudinally positioned between third rib 134 and fourth rib 136. A second land 142 annularly extends along an axial extent of second seal gland 96.

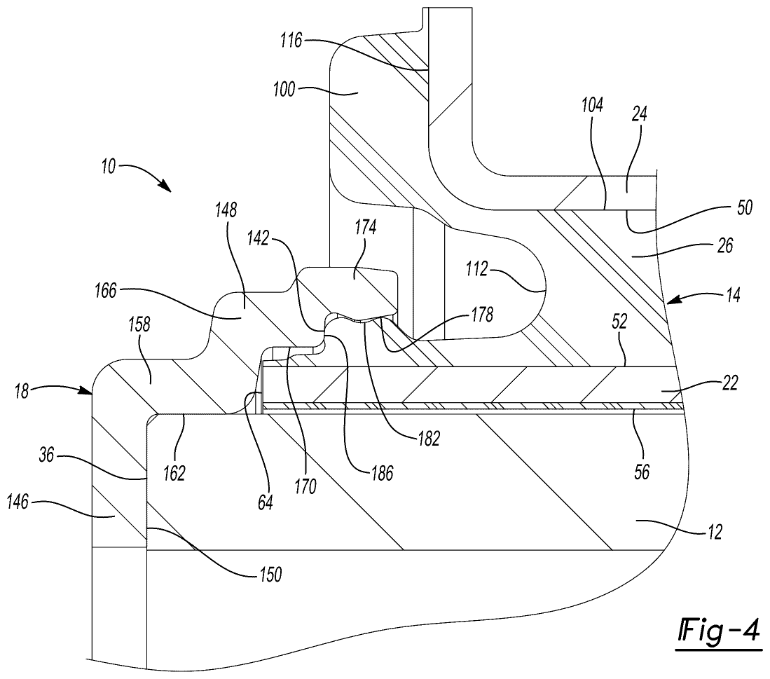

With reference to FIG. 4, second cap 18 is shown at an assembled position relative to inner sleeve 12 and bearing assembly 14. Second cap 18 is substantially similar to first cap 16. As such, only second cap 18 will be described in detail. Second cap 18 may be constructed from a mild steel as a one-piece component including an end wall 146 and a stepped cylindrical sidewall 148. End wall 146 includes a first face 150 positioned in engagement with first end face 36 of inner sleeve 12. Stepped sidewall 148 includes a first cylindrical portion 158 longitudinally extending from end wall 146. First cylindrical portion 158 includes an inner surface 162 defining a first inner diameter slightly less than an outer diameter defined by outer surface 46 of inner sleeve 12. Therefore, each of first cap 16 and second cap 18 are retained on inner sleeve 12 in a press fit.

A second cylindrical portion 166 of sidewall 148 includes an inner surface 170 defining a second inner diameter having a size greater than the first inner diameter defined by inner surface 162. Inner surface 170 remains clear or otherwise spaced apart from bearing assembly 14. Second cap 18 includes a third cylindrical portion 174 including a circumferentially extending inner surface 178. Inner surface 178 is shown to include a contour and is not shaped as a right circular cylinder. It should be appreciated that the shape of this sealing surface may vary from that depicted in the figures without departing from the scope of the present disclosure. In the embodiment depicted, inner surface 178 includes a circumferentially extending ridge 182.

Second cap 18 includes an annular sealing face 186 positioned at the transition between second cylindrical portion 166 and third cylindrical portion 174. Once second cap 18 is disposed at its installed position as depicted in FIG. 4, annular sealing face 186 engages second land 142 in sealing engagement. Second seal gland 96 is axially compressed as second cap 18 is being installed to its assembled position. Ridge 182 is longitudinally positioned to align with circumferentially extending trough 138. Third cylindrical portion 174 includes a radial thickness to position inner circumferential surface 178 at a location sealingly engaged with at least one of third rib 134 and fourth rib 136. Second seal gland 96 is radially compressed toward the longitudinal centerline by inner circumferential surface 178. Third cylindrical portion 174 is positioned within second annular void 112. Seals are formed at two spaced apart interfaces-namely between annular sealing face 186 and second land 142 as well as between inner circumferential surface 178 and at least one of third rib 134 and fourth rib 136. Contaminant ingress to the interface between inner sleeve 12 and bearing 22 is prevented. As the seals previously described may be characterized as rotary seals due to the relative rotation between second cap 18 and elastomer 26, it may be beneficial to coat first cap 16 and second cap 18 with a friction reducing material such as Zinc or Nickle plating. As previously mentioned, elastomer 26 may include an internal lubricant, as well.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

What is claimed is:

1. An elastomeric bushing comprising:
an inner sleeve including a first end face and an opposite second end face;
a bearing circumscribing the inner sleeve;
an elastomer disposed around and directly engaging the bearing, the elastomer including a first seal gland;
an outer sleeve disposed around the bearing and the elastomer, the outer sleeve being spaced apart from the inner sleeve and directly engaging the elastomer;
a one-piece monolithic first cap including an end wall and a sidewall surrounding a portion of the inner sleeve and a portion of the bearing, the end wall radially inwardly extending from the sidewall and overlapping the first end face of the inner sleeve, the stepped sidewall having an inner surface positioned in engagement with the first seal gland.

2. The elastomeric bushing according to claim 1, wherein the first cap and the first seal gland are configured to allow relative rotary movement therebetween.

3. The elastomeric bushing according to claim 2, wherein the first cap is fixed to the inner sleeve.

4. The elastomeric bushing according to claim 1, wherein the first seal gland includes a first circumferentially extending rib and a second circumferentially extending rib longitudinally spaced apart from the first rib.

5. The elastomeric bushing according to claim 1, wherein the first seal gland includes an annular land in direct engagement with a portion of the stepped sidewall of the first cap.

6. The elastomeric bushing according to claim 4, wherein an inner surface of the stepped sidewall of the first cap engages and compresses at least one of the first rib and the second rib.

7. The elastomeric bushing according to claim 1, wherein the first cap is spaced apart from the bearing.

8. The elastomeric bushing according to claim 1, wherein the end wall of the first cap directly engages the first end face of the inner sleeve.

9. The elastomeric bushing according to claim 1, wherein the bearing includes an inner cylindrical surface including a PTFE coating.

10. The elastomeric pushing according to claim 1, wherein the inner sleeve is axially translatable and rotatable relative to the bearing.

11. The elastomeric bushing according to claim 10, wherein the first cap limits axial travel of the inner sleeve relative to the bearing.

12. The elastomeric bushing according to claim 1, wherein the outer sleeve includes a radially outwardly extending flange.

13. The elastomeric bushing according to claim 12, wherein the elastomer includes a circumferentially extending bumper bonded to the flange of the outer sleeve.

14. The elastomeric bushing according to claim 1, wherein an inner surface of the outer sleeve is bonded to the elastomer.

15. The elastomeric bushing according to claim 1, wherein the first cap is press fit to the inner sleeve.

16. An elastomeric bushing comprising:
an inner sleeve including a first end face and an opposite second end face;
a bearing circumscribing the inner sleeve;
an elastomer disposed around and directly engaging the bearing, the elastomer including a first seal gland, a second seal gland, a first annular void, and a spaced apart second annular void;
an outer sleeve disposed around the bearing and the elastomer, the outer sleeve being spaced apart from the inner sleeve and directly engaging the elastomer, the outer sleeve including a first end and an opposite second end;
a one-piece monolithic first cap including a stepped cylindrical sidewall surrounding a portion of the inner sleeve and a portion of the bearing, and an end wall, the end wall radially inwardly extending from the sidewall and overlapping the first end face of the inner sleeve, the stepped sidewall having an inner surface positioned in engagement with the first seal gland and within the first annular void; and
a one-piece monolithic second cap overlapping the second end face and surrounding a portion of the inner sleeve and a portion of the bearing, the second cap including a stepped cylindrical sidewall positioned in engagement with the second seal gland and within the second annular void.

17. The elastomeric bushing according to claim 16, wherein the first seal gland includes a first circumferentially extending rib and a second circumferentially extending rib longitudinally spaced apart from the first rib.

18. The elastomeric bushing according to claim 17, wherein the first seal gland includes an annular land in direct engagement with a portion of the stepped sidewall of the first cap.

19. The elastomeric bushing according to claim 17, wherein an inner surface of the stepped sidewall of the first cap engages and compresses at least one of the first rib and the second rib.

20. The elastomeric bushing according to claim 16, wherein the first cap and the first seal gland are configured to allow relative rotary movement therebetween.
